(19) United States
(12) Patent Application Publication
(10) Pub. No.: US 2021/0253427 A1
(43) Pub. Date: Aug. 19, 2021

(54) CARBON-BASED ANODE MATERIAL WITH HIGH SLOPECAPACITY AND PREPARATION METHOD THEREFOR AND USE THEREOF

(71) Applicant: Institute of Physics, The Chinese Academy of Sciences, Beijing (CN)

(72) Inventors: Yongsheng Hu, Beijing (CN); Yuruo Qi, Beijing (CN); Yaxiang Lu, Beijing (CN); Liquan Chen, Beijing (CN)

(73) Assignee: Institute of Physics, The Chinese Academy of Sciences, Beijing (CN)

(21) Appl. No.: 16/973,358

(22) PCT Filed: Jun. 3, 2019
(86) PCT No.: PCT/CN2019/089753

§ 371 Date: Dec. 8, 2020

(30) Foreign Application Priority Data
Jun. 8, 2018 (CN) 201810584942.7

(51) Int. Cl. C01B 32/05; H01M 10/0525

(52) U.S. Cl. CPC C01B 32/05; H01M 2004/021; H01M 10/0525

(57) ABSTRACT

A carbon-based anode material with high ramp capacity, a preparation method therefore, and a use thereof. The method includes placing a carbon source precursor into a crucible and heating to 400° C-1000° C. at a heating rate of 0.2° C./min-30° C./min under an inert atmosphere, wherein the precursor includes any one or a combination of at least two of fossil fuel, biomass, resin, and organic chemicals; and carrying out heat treatment on the precursor at a temperature of 400° C. to 1000° C. for 0.5-48 hours to carbonize the precursor to obtain a carbon-based negative electrode material. The specific surface area of the anode material is less than 10 m²/g. and assembling the obtained electrode material into a sodium ion battery and then carrying out charging and discharging between 0 and 2.5 V, to obtain a voltage curve. The ramp capacity being above 180 mAh/g and the first-cycle Coulombic efficiency is above 75%.

### CROSS-REFERENCE TO RELATED APPLICATIONS

This application is a national phase entry under 35 U.S.C. § 371 of International Patent Application PCT/CN2019/089753, filed Jun. 3, 2019, designating the United States of America and published as International Patent Publication WO 2019/233357 A1 on Dec. 12, 2019, which claims the benefit under Article 8 of the Patent Cooperation Treaty to Chinese Patent Application Serial No. 201810584942.7, filed Jun. 8, 2018.

### TECHNICAL FIELD

The present disclosure relates to the technical field of materials and, in particular, to a carbon-based anode material with high slope capacity and a preparation method and use thereof.

### BACKGROUND

Energy is the basis for human society to survive, and with the development of human society, people's demand for energy is increasing. Human energy currently mainly comes from fossil fuels such as petroleum, coal and natural gas, but these energy reserves are limited, which is difficult to maintain the sustainable development of mankind, and serious greenhouse effect and environmental pollution problems will be caused. In recent years, clean energy represented by solar energy, wind energy, tidal energy, etc. have received widespread attention, but the output of these energy sources has time discontinuity and spatial distribution unevenness. Therefore, the research and development of high-efficiency and low-cost large-scale energy storage technology has become a key link in the sustainable development of energy and an important part of the country's future energy strategy. Energy storage technology mainly includes physical energy storage and chemical energy storage. Physical energy storage includes compressed air energy storage, pumped water power storage, flywheel energy storage and superconducting magnetic energy storage. Chemical energy storage mainly refers to electrochemical energy storage, including lithium-ion batteries, lead-acid batteries, all-vanadium redox flow batteries, high-temperature sodium-sulfur batteries, and super capacitors. An electrochemical energy storage system with an efficiency higher than 80% can meet the needs of the large-scale energy storage market. Compared with several other energy storage technologies, lithium-ion batteries have shown great advantages in the field of energy storage applications and have become the first choice for new energy power batteries that have emerged recently. The production of lithium-ion batteries has reached an unprecedented scale, which will inevitably lead to the massive consumption of lithium resources and rising prices. In fact, lithium is not abundant in the earth's crust, and its resource distribution is very uneven, mainly in South America. The rising price of lithium resources gradually requires people to pay attention to other similar battery systems.

Sodium and lithium are in the same main family and have similar chemical properties, and sodium is abundant in the earth's crust. Compared with lithium-ion batteries, sodium-ion batteries have once again become a research hotspot for scientific researchers due to their very large resource advantages. The anode material is an important factor restricting the large-scale development of sodium ion batteries. Since metal sodium is relatively active, it cannot be used as an anode in an actual sodium ion battery. The graphite anode, which is widely used in lithium-ion batteries, has almost no sodium storage capacity due to thermodynamic reasons, so the research and development of anode materials for sodium-ion batteries is facing great difficulties and challenges. At present, the widely studied anode materials for sodium ion batteries mainly include carbon-based anode materials, transition metal oxides, alloy anode materials and organic compounds. Among them, carbon-based anode materials have become the most promising anode materials for sodium ion batteries due to their relatively high sodium storage capacity, low sodium storage potential and excellent cycle stability.

Most of the electrochemical curves of carbon-based anode materials reported in the current research include a plateau section (the plateau section refers to a section of the electrochemical curve where the slope of the curve is almost 0) and a slope section (the slope section refers to a section of the electrochemical curve where the slope of the curve is non-zero). In order to quantitatively describe the slope section, there are two definitions in different References according to the characteristics of the actual electrochemical curve and the author's preference: the section with a slope of 0.2 V or above is considered as a slope section, or the section with a slope of 0.1 V or above is considered as a slope section. But in fact, the capacity contribution between 0.1 V and 0.2 V is not large, so it can be collectively considered that the section with a slope of 0.1V or above is a slope section. The kinetic speed of the charge and discharge process of the plateau section is very slow, which will lead to poor rate performance. However, the power characteristics of the battery system significantly depend on the rate performance of the anode material. Further improving the rate performance of the carbon-based anode material is the focus of researchers and is also a fundamental driving force for the commercialization of sodium ion batteries. Therefore, the development of a high-rate carbon-based anode material has become a research focus. Compared with the plateau section with a poor kinetic speed, the slope section has a better rate capability. Therefore, the development of a carbon-based anode material, which only has a slope section or has most of the capacity coming from the slope section is an important means to solve the poor rate performance of carbon-based anode materials. However, such carbon-based anode materials reported in current researches have low reversible specific capacity or low initial Coulombic efficiency (generally less than 50%). When such carbon-based anode materials are applied to a full battery, the lower reversible specific capacity cannot meet the energy density requirements of the battery system. The lower initial Coulombic efficiency will consume a large amount of the limited sodium ions from a cathode, thereby reducing the energy density and cycle life of the battery system. Therefore, the development of a method for preparing a carbon-based anode material with high capacity, high rate, high initial efficiency is the key to realize the industrial application of sodium ion batteries, and it has very large application prospects.

In addition, with the exception of some organic polymers, the current pyrolysis process of carbon-based anode materials is performed at a relatively high temperature, often greater than 1000° C. However, the initial efficiency of organic polymer-derived carbon-based anode materials carbonized at lower temperatures is relatively low (generally less than 50%), which is not conducive to the performance of the full battery. It is not reported at present that the carbon source precursor is pyrolyzed at a relatively low temperature to obtain a carbon-based anode material with high capacity, high initial efficiency, and high rate. Therefore, it has great research significance and industrial application prospects to look for some special carbon source precursors that undergo pyrolysis at relatively low temperatures to prepare a carbon-based anode material with high capacity, high first-cycle efficiency, and high rate.

### BRIEF SUMMARY

The objective of the present disclosure is to provide a carbon-based anode material with high slope capacity and a preparation method and application thereof. The preparation process is simple and easy, the carbonization temperature is low, and a voltage curve with high slope capacity is obtained, and the reversible specific capacity, initial Coulombic efficiency, cycle performance and rate performance of the material are also ensured.

To achieve the above objective, in the first aspect, the present disclosure provides a preparation method of a carbon-based anode material with high slope capacity, including:

placing a carbon source precursor in a crucible, placing the crucible in a heating device, and heating to 400° C.-1000° C. at a heating rate of 0.2° C./min-30° C./min under an inert atmosphere, wherein the carbon source precursor includes: any one or a combination of at least two of fossil fuels, biomass, resins, and organic chemicals;

the fossil fuels include: one or more of anthracite, bituminous coal, pitch, coal tar, and paraffin; the biomass includes one or more of corn stalks, cotton, lignin, cellulose, and glucose; the resins include one or more of phenolic resin, epoxy resin, polyamide resin, polyester resin and rosin; the organic chemicals include: one or more of sodium carboxymethyl cellulose, sodium alginate, sodium citrate, calcium hydroxyphosphate, and calcium gluconate; and carrying out low-temperature heat treatment on the carbon source precursor at 400° C.-1000° C. for 0.5-48 hours to carbonize the carbon source precursor, thus obtaining the carbon-based anode material with high slope capacity, wherein, the carbon-based anode material obtained by the low-temperature heat treatment has a specific surface area of less than 10 m²/g, a slope capacity of 180 mAh/g or above, and an initial Coulombic efficiency of 75% or above.

Preferably, temperature for the low-temperature heat treatment is 600° C.-900° C., the time is from 0.5 hours to 10 hours, and the heating rate is 1° C./min-10° C./min.

Preferably, inert gas forming the inert atmosphere specifically includes any one of N₂, Ar, Ar-5%H₂, Ar-10%H₂, and Ar-40%H₂.

Preferably, the carrying out low-temperature heat treatment on the carbon source precursor further includes: introducing the inert gas and a hydrocarbon-containing gas during the low-temperature heat treatment process, so that the carbon source precursor is subjected to surface coating during carbonization, wherein the hydrocarbon-containing gas includes one or more of methane, ethane, toluene, ethylene, acetylene, and propyne, with a flow rate of 0.5-200 mL/min.

Preferably, before the carbonization of the carbon source precursor, the method further includes:
pretreating the carbon source precursor,
wherein the pretreatment includes one or more of pre-oxidation, acid washing, alkali washing, water washing, organic solvent washing, and carbon coating treatment.

Preferably, after the carbonization of the carbon source precursor, the method further includes:
carrying out acid washing, alkali washing, water washing, organic solvent washing and/or carbon coating treatment on the carbonization product.

In the second aspect, an embodiment of the present disclosure provides a carbon-based anode material prepared by the preparation method described in the first aspect. The specific surface area of the carbon-based anode material is less than 10 m²/g, and the intensity ratio ID/IG of the D-peak and G-peak in the Raman spectrum is between 1.5 and 5.

Preferably, the carbon-based anode material is used as the anode material of a secondary battery.

In a third aspect, an embodiment of the present disclosure provides a secondary battery, including the carbon-based anode material described in the second aspect.

The preparation method of the carbon-based anode material with high slope capacity provided by the embodiment of the present disclosure has a low carbonization temperature, is simple and easy, and can be prepared on a large scale; the specific surface area of the prepared carbon-based material is less than 10 m²/g, and the ID/IG value calculated by the Raman spectrum is large (between 1.5 and 5); the carbon-based material is used as the anode material of a secondary battery to obtain a voltage curve with a high slope capacity, and moreover, it has a high initial Coulombic efficiency and reversible specific capacity; in the case of charge and discharge between 0 and 2.5 V, almost all the reversible specific capacity obtained comes from the slope section, the reversible specific capacity can be as high as 231.4 mAh/g, and the initial Coulombic efficiency is as high as 80%.

### BRIEF DESCRIPTION OF THE DRAWINGS

FIG. 1 is an X-ray diffraction (XRD) pattern of the carbon-based anode material prepared in Embodiment 1;

FIG. 2 is a scanning electron microscope (SEM) image of the carbon-based anode material prepared in Embodiment 1;

FIG. 3 is a charge-discharge curve diagram of the carbon-based anode material prepared in Embodiment 1;

FIG. 4 is a Raman spectrum of the carbon-based anode material prepared in Embodiment 2;

FIG. 5 is a charge-discharge curve diagram of the carbon-based anode material prepared in Embodiment 3;

FIG. 6 is a transmission electron microscope (TEM) image of the carbon-based anode material prepared in Embodiment 4;

FIG. 7 is a diagram of the cycle performance of the carbon-based anode material prepared in Embodiment 5;

FIG. 8 is a charge-discharge curve diagram of the carbon-based anode material prepared in Embodiment 7;

FIG. 9 is a charge-discharge curve diagram of the carbon-based anode material prepared in Embodiment 8;

FIG. 10 is a diagram of the rate performance of the carbon-based anode material prepared in Embodiment 9;

FIG. 11 is a scanning electron microscope (SEM) image of the carbon-based anode material prepared in Embodiment 11;

FIG. 12 is a scanning electron microscope (SEM) image of the carbon-based anode material prepared in Embodiment 12;

FIG. 13 is an X-ray diffraction (XRD) pattern of the carbon-based anode material prepared in Embodiment 13;

FIG. 14 is a scanning electron microscope (SEM) image of the carbon-based anode material prepared in Embodiment 13;

FIG. 15 is a charge-discharge curve diagram of the carbon-based anode material prepared in Embodiment 13;

FIG. 16 is a charge-discharge curve diagram of the carbon-based anode material prepared in Embodiment 14;

FIG. 17 is an X-ray diffraction (XRD) pattern of the carbon-based anode material prepared in Comparative Embodiment 1;

FIG. 18 is a scanning electron microscope (SEM) image of the carbon-based anode material prepared in Comparative Embodiment 1;

FIG. 19 is a transmission electron microscope (TEM) image of the carbon-based anode material prepared in Comparative Embodiment 1;

FIG. 20 is a charge-discharge curve diagram of the carbon-based anode material prepared in Comparative Embodiment 1;

FIG. 21 is a charge-discharge curve diagram of the carbon-based anode material prepared in Comparative Embodiment 2; and

FIG. 22 is a comparison diagram of charge-discharge curves of the carbon-based anode materials of Embodiment 1, comparative Embodiment 1, and comparative Embodiment 2.

### DETAILED DESCRIPTION

The technical solutions of the present disclosure will be further described in detail below through the accompanying drawings and embodiments.

An embodiment of the present disclosure provides a preparation method of a carbon-based anode material with high slope capacity, including:

placing a required amount of a carbon source precursor in a crucible, placing the crucible into a heating device, heating to 400° C.-1000° C. at a heating rate of 0.2° C./min-30° C./min under an inert atmosphere, and then carrying out low-temperature heat treatment on the carbon source precursor at 400° C.-1000° C. for 0.5-48 hours to carbonize the carbon source precursor, thus obtaining a carbon-based anode material.

Wherein the carbon source precursor compound is any one or a combination of at least two of fossil fuels, biomass, resins, and organic chemicals, such as a combination of fossil fuel and biomass, a combination of fossil fuel and resin, a combination of fossil fuel and organic chemicals, a combination of biomass and resin, a combination of biomass and organic chemicals, a combination of resin and organic chemicals, a combination of fossil fuel, biomass, and resin, a combination of fossil fuel, biomass, and organic chemicals, a combination of biomass, resin, and organic chemicals, and a combination of fossil fuel, biomass, resin, and organic chemicals.

The fossil fuels include: one or more of anthracite, bituminous coal, pitch, coal tar, and paraffin; the biomass includes one or more of corn stalks, cotton, lignin, cellulose, and glucose; the resins include one or more of phenolic resin, epoxy resin, polyamide resin, polyester resin and rosin; the organic chemicals include: one or more of sodium carboxymethyl cellulose, sodium alginate, sodium citrate, calcium hydroxyphosphate, and calcium gluconate.

In a preferred solution, the temperature of the low-temperature heat treatment ranges from 600° C. to 900° C., and, for example, specifically may be 600° C., 700° C., 800° C., or 900° C.; the time of the low-temperature heat treatment ranges from 0.5 hour to 10 hours, for example, preferably 40 minutes, 1 hour, 2 hours, 4 hours, 6 hours, or 8 hours; the heating rate ranges from 1° C./min to 10° C./min, for example, preferably 1° C./min, 3° C./min, 5° C./min, or 10° C./min.

The inert gas forming the inert atmosphere specifically includes any one of N₂, Ar, Ar-5%H₂, Ar-10%H₂, and Ar-40%H₂.

The carbon source precursor undergoes low-temperature heat treatment to form a carbon-based anode material with a special microstructure where the surface is slightly ordered, the interior is disordered, and no obvious graphitized crystallite area exists.

Preferably, the process of performing low-temperature heat treatment on the carbon source precursor may further include introducing inert gas and hydrocarbon-containing gas at the same time during the carbonization of the carbon source precursor, so that the carbon source precursor is also subjected to surface coating during carbonization. The hydrocarbon-containing gas may include one or more of methane, ethane, toluene, ethylene, acetylene, and propyne, with a flow rate of 0.5-200 mL/min.

In a preferred solution, the carbon source precursor may further be pretreated before the carbon source precursor is subjected to low-temperature heat treatment and carbonization, and the pretreatment includes one or more of pre-oxidation, acid washing, alkali washing, water washing, organic solvent washing, and carbon coating treatment.

In addition, after being carbonized, the carbon source precursor is taken out of the heating device and the crucible and then subjected to acid washing, alkali washing, water washing, organic solvent washing and/or carbon coating treatment, thus obtaining the carbon-based anode material with high slope capacity.

The carbon-based anode material with high slope capacity prepared by the present disclosure can be applied in the anode material of the secondary battery, such as the anode material of the sodium ion battery, and has excellent performance.

Compared with the prior art, the preparation method and the prepared material of the present disclosure have the following beneficial effects:

(1) Compared with the traditional carbonization process, the carbonization in the preparation process of the present disclosure is carried out at a significantly lower temperature, is simple and easy, needs a short processing time, and can be put into large-scale preparation.

(2) Compared with other materials obtained at higher temperatures (usually higher than 1000° C.), the carbon-based material prepared by the method provided by the present disclosure has high intensity ratio (ID/IG) of the D-peak and G-peak calculated by Raman spectroscopy, between 1.5 and 5, and high degree of disorder, and when the carbon-based material is applied to a sodium ion battery, in the case of charge and discharge between 0 and 2.5 V, a voltage curve with high slope capacity is obtained, where the slope capacity is 180 mAh/g or above, and the initial Coulombic efficiency is 75% or above. In a specific embodiment, the reversible specific capacity can be as high as 231.4 mAh/g, and the initial Coulombic efficiency can be as high as 80%.

(3) As compared with that of other existing materials prepared at low temperatures (600-1000° C.) the method provided by the present disclosure , by optimizing the precursor, carbonization temperature, and carbonization time, and in cooperation with the pre- and post-treatment process, and through adjusting the microstructure of the material, may obtain a higher reversible specific capacity, the specific surface area of the material less than 10 m²/g; and a higher initial Coulombic efficiency at the same time as the higher reversible specific capacity is obtained; wherein with a reversible specific capacity of up to 231.4 mAh/g, the initial Coulombic efficiency can be as high as 80%. During the carbonization process, inert gas and hydrocarbon-containing gas are introduced at the same time for surface coating, which can further reduce the specific surface area, improve the initial efficiency and reversible specific capacity.

(4) The present disclosure forms a carbon-based anode material with a special microstructure by selecting a suitable precursor and a lower treatment temperature. Taking pitch as the carbon source precursor as an example, the pitch is carbonized at a preferred temperature between 600° C. and 900° C. to form a carbon-based anode material with a special microstructure, where the ID/IG value calculated by Raman spectrum is large, the surface is slightly ordered, the interior is disordered, and no obvious graphitized crystallite area exists. The slightly ordered surface can improve the electronic conductance of the carbon-based anode material, and also facilitate the diffusion of alkali metal ions, thereby improving the reversible specific capacity and rate performance of the material, and also improving the initial reversible specific capacity of the material and the initial charge-discharge efficiency. The internal disordered structure can adjust the interaction between alkali metal ions and the carbon layers, thereby adjusting the potential, and obtaining an electrochemical curve with a high slope capacity. In addition, the prepared carbon-based anode material has a small specific surface area, which reduces the side reactions between the electrode and the electrolyte and improves the initial efficiency. The prepared carbon-based anode material has an initial efficiency of up to 80% and an initial charge capacity of up to 234 mAh/g, almost all of which comes from the slope section. The carbon-based anode material with high slope capacity has fast ion diffusion speed, low polarization and good rate performance during charge and discharge process, which is beneficial to high-current charge and discharge of full batteries.

Hereinafter, some specific embodiments are used to further illustrate the preparation method and material properties of the carbon-based anode material of the present disclosure. The following examples are intended to illustrate the present disclosure, but not to further limit the present disclosure.

### Embodiment 1

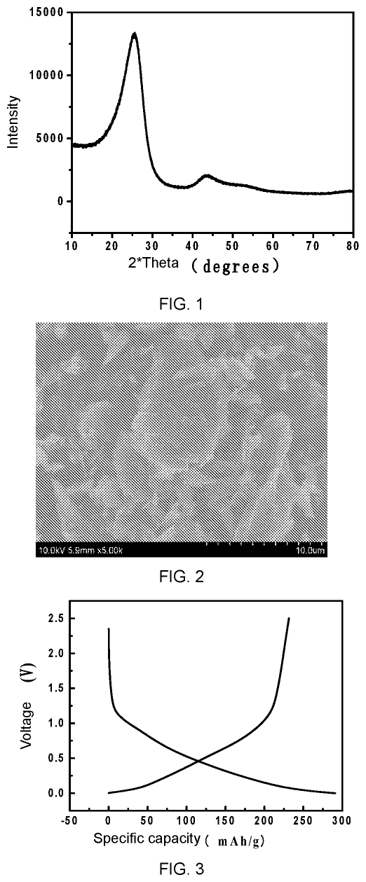

1 g of pitch is placed into a 20 mL graphite crucible, and the graphite crucible is then placed into a tube furnace where the pitch is carbonized at 950° C. for 2 hours under an Ar atmosphere, thus obtaining the final carbon-based anode material. The X-ray diffraction (XRD) pattern and scanning electron microscope (SEM) image of the carbon-based anode material are shown in FIG. 1 to FIG. 2. The X-ray diffraction (XRD) pattern has no obvious diffraction peak, indicating that the obtained carbon-based anode material is an amorphous carbon-based anode material. The obtained carbon-based anode material is made into a pole piece, which is assembled into a button cell with sodium metal as a counter electrode and 1 mol/L NaPF6 EC/DMC (1:1) as electrolyte. Its charge-discharge curve is measured at 0.1C. As shown in FIG. 3, the test results show that the electrochemical curve basically only includes a slope section (see FIG. 21 of Comparative Embodiment 2. In Comparative Embodiment 2, the electrochemical curve includes both a plateau section and a slope section. In such embodiment of the disclosure, there is almost no platform section, only a slope section), the reversible specific capacity is 231.4 mAh/g, and the initial Coulombic efficiency is 80%.

### Embodiment 2

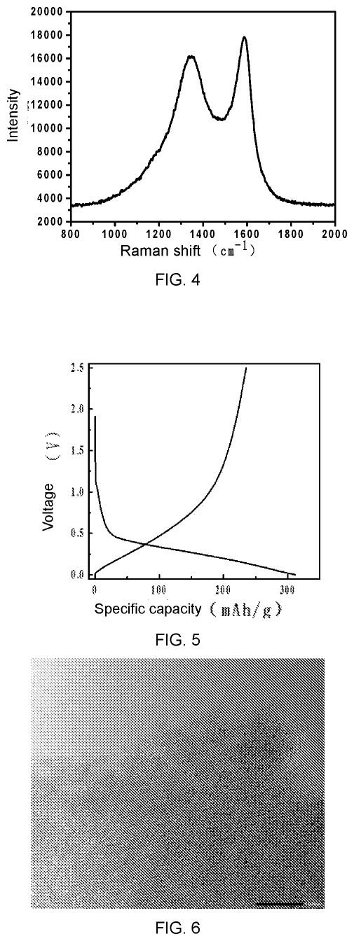

1 g of anthracite is placed in a 20 mL graphite crucible, and the crucible is then placed in a muffle furnace to keep the anthracite at 350° C. for 12 hours. The material taken out is treated at 650° C. for 24 hours under an Ar atmosphere, thus obtaining the final carbon-based anode material. The Raman spectrum of the carbon-based anode material is shown in FIG. 4, and the ID/IG value calculated by the Raman spectrum is 2.57, which shows that the prepared carbon-based anode material has a high degree of disorder and small graphitized flakes. The obtained carbon-based anode material is made into a pole piece, which is assembled into a button cell with sodium metal as a counter electrode and 1 mol/L NaPF₆ EC/DMC (1:1) as electrolyte. Its charge-discharge curve is measured at 0.1C. The first-cycle charge capacity is as high as 219.1 mAh/g, almost all of which comes from the slope section, and the initial Coulombic efficiency is as high as 79%.

### Embodiment 3

2 g of corn stalks are crushed, dispersed in 50 mL of water, and placed in a 100 mL beaker, and the beaker is then placed in an oven where the resulting material is heated to 180° C. and kept at 180° C. for 24 hours. Then the washed and dried powder is put in a tube furnace and treated at 700° C. for 10 hours in a N₂ atmosphere, thus obtaining the final carbon-based anode material. The obtained carbon-based anode material is made into a pole piece, which is assembled into a button cell with sodium metal as a counter electrode and 1 mol/L NaPF₆ EC/DMC (1:1) as electrolyte. Its charge-discharge curve is measured at 0.1C. As shown in FIG. 5, the test results show that the capacity is as high as 230.5 mAh/g, almost all of which comes from the slope section, and the initial Coulombic efficiency is as high as 75.9%.

### Embodiment 4

2 g of phenolic resin is dispersed in 50 mL of 3 mol/L HCl, the resulting material is sealed and put in an oven to be kept at 180° C. for 12 hours, and then the resulting material is washed with deionized water to be neutral and dried at 60° C. Then the material is treated at 750° C. for 15 hours under a N₂ atmosphere, thus obtaining the final carbon-based anode material. The TEM spectrum of the carbon-based anode material is shown in FIG. 6. The TEM spectrum shows that there is no obvious graphitized crystallite area in the prepared carbon-based anode material, and there are curved carbon layers on the surface, the surface is slightly ordered, but the interior is disordered. The obtained carbon-based anode material is made into a pole piece, which is assembled into a button cell with sodium metal as a counter electrode and 1 mol/L NaPF₆ EC/DMC (1:1) as electrolyte. Its charge-discharge curve is measured at 0.1C. The first-cycle charge capacity is as high as 227.2 mAh/g, almost all of which comes from the slope section, and the initial Coulombic efficiency is as high as 78.8%.

### Embodiment 5

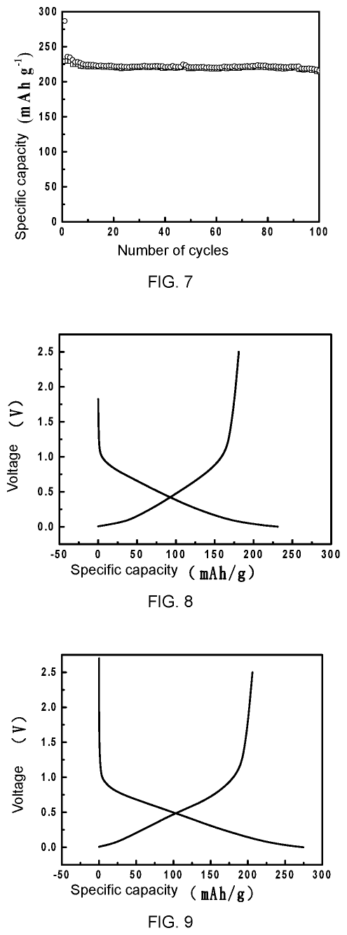

2 g of cellulase is dispersed in 50 mL of 4 mol/L NaOH, the resulting material is sealed and put in an oven to be kept at 180° C. for 2 hours, and then the resulting material is washed with deionized water to be neutral and dried at 60° C. The resulting material is treated at 850° C. for 1 hour under an Ar atmosphere, thus obtaining the final carbon-based anode material. The obtained carbon-based anode material is made into a pole piece, which is assembled into a button cell with sodium metal as a counter electrode and 1 mol/L NaPF₆ EC/DMC (1:1) as electrolyte. Its charge-discharge curve is measured at 0.1C. The first-cycle charge capacity is as high as 229.3 mAh/g, almost all of which comes from the slope section, and the initial Coulombic efficiency is as high as 80.3%. The cycle performance of the carbon-based anode material is shown in FIG. 7. There is no obvious capacity decay after 100 cycles at 0.1C.

### Embodiment 6

2 g of rosin is dispersed in 40 mL of 6 mol/L HCl; the resulting material is sealed and put in an oven to be kept at 80° C. for 24 hours; and then the resulting material is washed twice with 1 mol/L NaOH solution, then washed once with deionized water, and dried at 60° C. The resulting material is treated at 750° C. for 40 hour under an Ar-5%H₂ atmosphere, thus obtaining the final carbon-based anode material. The obtained carbon-based anode material is made into a pole piece, which is assembled into a button cell with sodium metal as a counter electrode and 1 mol/L NaPF₆ EC/DMC (1:1) as electrolyte. Its charge-discharge curve is measured at 0.1C. The first-cycle charge capacity is as high as 217.2 mAh/g, almost all of which comes from the slope section, and the first-cycle Coulombic efficiency is as high as 80.6%.

### Embodiment 7

10 g of calcium gluconate is placed into a 100 mL graphite crucible, and the graphite crucible is then placed into a tube furnace where the calcium gluconate is carbonized at 650° C. for 1 hour under an Ar-10%H₂ atmosphere. The obtained carbon-based anode material is washed 6 times with 6 mol/L HCl, and then washed with deionized water to be neutral, thus obtaining the final carbon-based negative electrode material. The obtained carbon-based anode material is made into a pole piece, which is assembled into a button cell with sodium metal as a counter electrode and 1 mol/L NaPF₆ EC/DMC (1:1) as electrolyte. Its charge-discharge curve is measured at 0.1C. As shown in FIG. 8, the test results show that the capacity is as high as 181 mAh/g, almost all of which comes from the slope section, and the initial Coulombic efficiency is as high as 78.4%.

### Embodiment 8

1 g of glucose is dissolved in 50 ml of water and placed in a 100 mL beaker, and the beaker is then placed in an oven to keep at 180° C. for 24 hours. Then the washed and dried powder is put in a tube furnace and treated at 700° C. for 2 hours in a mixed atmosphere of Ar and methylbenzene, and surface carbon coating is also completed during the carbonization process. The obtained powder is the final carbon-based anode material. The obtained carbon-based anode material is made into a pole piece, which is assembled into a button cell with sodium metal as a counter electrode and 1 mol/L NaPF₆ EC/DMC (1:1) as electrolyte. Its charge-discharge curve is measured at 0.1C. As shown in FIG. 9, the first-cycle charge capacity is as high as 206.2 mAh/g, most of the reversible specific capacity comes from the slope section, and the initial Coulombic efficiency is as high as 75.1%.

### Embodiment 9

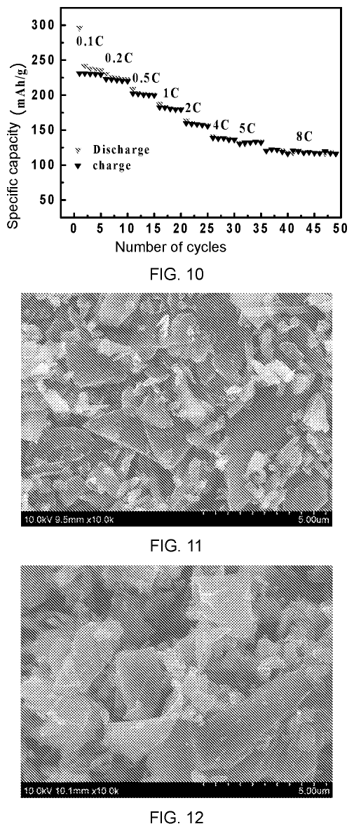

1 g glucose and 1 g of pitch are mixed mechanically and placed in a 100 mL graphite crucible, and the crucible is then placed in a tube furnace where the material is treated at 800° C. for 12 hours in an Ar-40%th atmosphere. The glucose is cracked to obtain a carbon nucleus, and the pitch is melt-coated on the surface of the glucose carbon-based anode material. The obtained material is the final carbon-based anode material. The obtained carbon-based anode material is made into a pole piece, which is assembled into a button cell with sodium metal as a counter electrode and 1 mol/L NaPF₆ EC/DMC (1:1) as electrolyte. Its charge-discharge curve is measured at 0.1C. The first-cycle charge capacity is as high as 230.1 mAh/g, almost all of which comes from the slope section, and the initial Coulombic efficiency is as high as 76.8%. The rate performance of the carbon-based anode material is shown in FIG. 10. The reversible specific capacity at 8C is 122 mAh/g, which is 53% of the capacity at 0.1C.

### Embodiment 10

1 g of coal tar and 1 g of phenolic resin are mixed in 100 mL of ethanol, and dried at 60° C. and then put in a 20 mL alumina crucible; and the crucible is placed in a tube furnace where the material is treated at 900° C. for 5 hours under a N₂ atmosphere. The resulting material is the final carbon-based anode material. The obtained carbon-based anode material is made into a pole piece, which is assembled into a button cell with sodium metal as a counter electrode and 1 mol/L NaPF₆ EC/DMC (1:1) as electrolyte. Its charge-discharge curve is measured at 0.1C. The first-cycle charge capacity is as high as 198.2 mAh/g, almost all of which comes from the slope section, and the initial Coulombic efficiency is as high as 75%.

### Embodiment 11

1 g of calcium hydroxyphosphate and 1.8 g of pitch are mechanically mixed and ground, and then placed in a 50 mL alumina crucible; and the crucible is then placed in a muffle furnace and kept at 300° C. for 24 hours. The material taken out is treated at 850° C. for 1 hour in a N₂ atmosphere. The resulting material is the final carbon-based anode material. The SEM image of the carbon-based anode material is shown in FIG. 11. The obtained carbon-based anode material is made into a pole piece, which is assembled into a button cell with sodium metal as a counter electrode and 1 mol/L NaPF₆ EC/DMC (1:1) as electrolyte. Its charge-discharge curve is measured at 0.1C. The first-cycle charge capacity is as high as 217 mAh/g, almost all of which comes from the slope section, and the initial Coulombic efficiency is as high as 79.8%.

### Embodiment 12

1 g of bituminous coal, 3 g of cellulose, and 0.5 g of sodium citrate are dissolved in 20 mL of ethanol solution and placed in a 50 mL beaker; and the beaker is then placed in an oven and heated to 220° C. and kept at 220° C. for 48 hours. The material taken out is treated at 1000° C. for 5 hours under an Ar-10%H₂ atmosphere. The resulting material is the final carbon-based anode material. The SEM image of the carbon-based anode material is shown in FIG. 12. The obtained carbon-based anode material is made into a pole piece, which is assembled into a button cell with sodium metal as a counter electrode and 1 mol/L NaPF₆ EC/DMC (1:1) as electrolyte. Its charge-discharge curve is measured at 0.1C. The first-cycle charge capacity is as high as 221 mAh/g, almost all of which comes from the slope section, and the initial Coulombic efficiency is as high as 80%.

### Embodiment 13

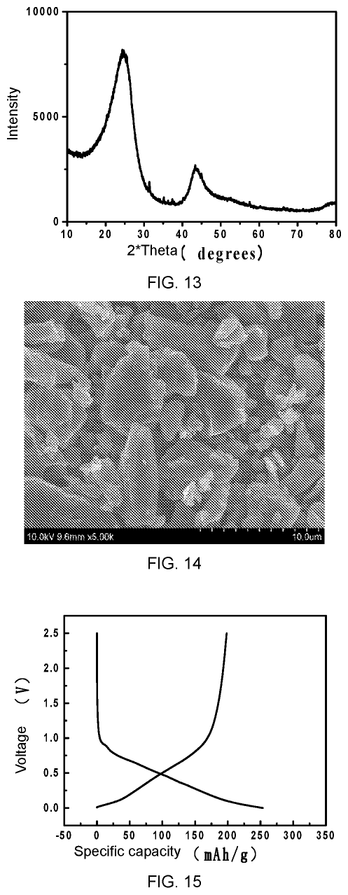

2 g of anthracite, 2.4 g of cotton, 1.2 g of epoxy resin, and 0.4 g of calcium gluconate are well mixed and ground and placed in a 40 mL alumina crucible; and the crucible is then placed in a tube furnace where the material is carbonized at 1000° C. for 48 hours in an Ar atmosphere. The XRD pattern and SEM image of the obtained carbon-based anode material are shown in FIGS. 13-14. The XRD pattern has no obvious diffraction peak, indicating that the obtained carbon-based anode material is an amorphous carbon-based anode material. The obtained carbon-based anode material is made into a pole piece, which is assembled into a button cell with sodium metal as a counter electrode and 1 mol/L NaPF₆ EC/DMC (1:1) as electrolyte. Its charge-discharge curve is measured at 0.1C, as shown in FIG. 15. The test results show that the capacity is as high as 198.3 mAh/g, almost all of which comes from the slope section, and the initial Coulombic efficiency is as high as 78%.

### Embodiment 14

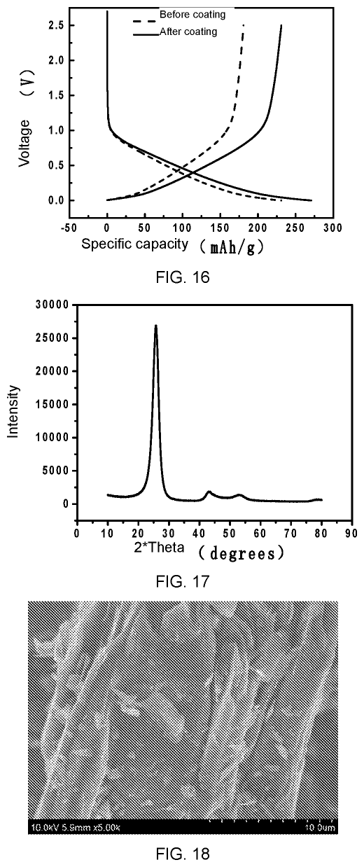

The carbon-based anode material obtained in Embodiment 7 is mixed and ground with pitch in a ratio of 1:0.1, and the resulting material is kept at 350° C. for 2 hours in an air atmosphere, and then carbonized in a mixed atmosphere of Ar and acetylene at 800° C. for 1 hour, thus obtaining the carbon-based anode material. The obtained carbon-based anode material is made into a pole piece, which is assembled into a button cell with sodium metal as a counter electrode and 1 mol/L NaPF₆ EC/DMC (1:1) as electrolyte. Its charge-discharge curve is measured at 0.1C. As shown in FIG. 16, the first-cycle efficiency is increased to 85%, and the reversible specific capacity is increased to 230 mAh/g, almost all of which comes from the slope section.

### Comparative Embodiment 1

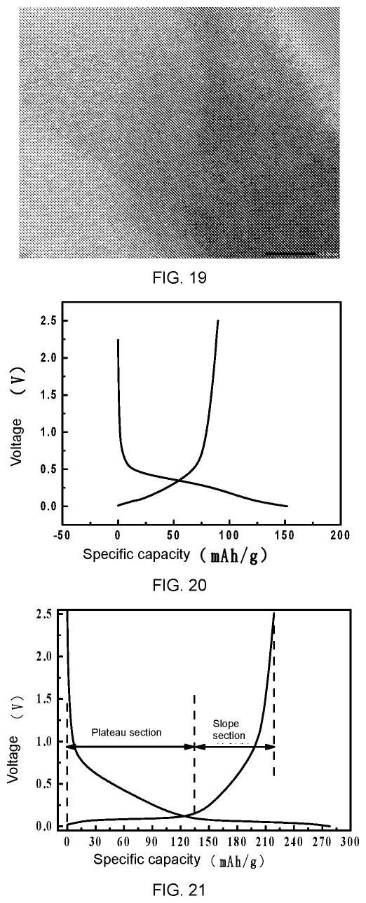

1 g of pitch is placed into a 20 mL graphite crucible, and the graphite crucible is then placed into a tube furnace where the pitch is carbonized at 1400° C. for 2 hours under a N₂ atmosphere, thus obtaining the final carbon-based anode material. The XRD pattern, SEM image, and the transmission electron microscope (TEM) image of the carbon-based anode material are shown in FIG. 17 to FIG. 19. The X-ray diffraction (XRD) pattern has an obvious diffraction peak, indicating that the obtained carbon-based anode material has an obvious graphitized structure. The SEM image shows that the surface of the obtained material has an obvious graphite layered structure. It can also be seen from the TEM spectrum that the carbon-based anode material prepared in Comparative Embodiment 1 has obvious graphitized carbon layers, of which the carbon layer spacing is small, and the graphitized flakes are larger. The obtained carbon-based anode material is made into a pole piece, which is assembled into a button cell with sodium metal as a counter electrode and 1 mol/L NaPF₆ EC/DMC (1:1) as electrolyte. Its charge-discharge curve is measured at 0.1C. As shown in FIG. 20, the test results show that the electrochemical curve basically only includes a slope section, but the first-cycle charge specific capacity is 89.7 mAh/g, and the initial Coulombic efficiency is 59.13%.

### Comparative Embodiment 2

2 g of anthracite is placed in a 40 mL alumina crucible, and the crucible is then placed in a tube furnace where the anthracite coal is carbonized at 1400° C. for 1 hour in an Ar-10% H₂ atmosphere. The obtained carbon-based anode material is made into a pole piece, which is assembled into a button cell with sodium metal as a counter electrode and 1 mol/L NaPF₆ EC/DMC (1:1) as electrolyte. Its charge-discharge curve is measured at 0.1C. As shown in FIG. 21, the test results show that the first-cycle charge specific capacity is 218.8 mAh/g and the slope section capacity (greater than 0.2 V) only accounts for 34%.

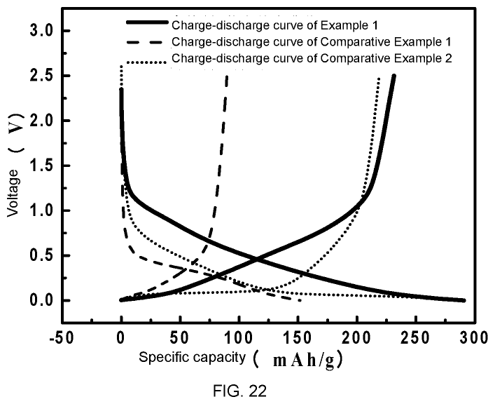

FIG. 22 is a comparison diagram of charge-discharge curves of the carbon-based anode materials of Embodiment 1, Comparative Embodiment 1, and Comparative Embodiment 2. It can be clearly seen from FIG. 22 that the curve of Embodiment 1 obtained by the preparation method of the carbon-based anode material with high slop capacity of the present disclosure almost only includes a slope section, and the reversible specific capacity is greater than 231.4 mAh/g. Although the curve obtained in Comparative Embodiment 1 basically only includes a slope section, the first-cycle charge specific capacity is only 89.7 mAh/g; the curve in Comparative Embodiment 2 has a first-cycle charge specific capacity of 218.8 mAh/g, but its slope section capacity only accounts for 34%. In the process of high-current charge and discharge, the plateau section is highly polarized, resulting in poor rate performance.

In summary, it can be seen that the present disclosure only needs to perform a short low-temperature heat treatment process at a relatively low temperature to obtain a carbon-based anode material with high capacity, high rate, and high first-cycle efficiency. By choosing a proper precursor, selecting a relatively low pyrolysis temperature, optimizing the pyrolysis temperature and in cooperation with the pre- and post-treatment process, and by virtue of a further carbon coating process, the purpose of adjusting the microstructure, macromorphology, crystallinity of the product and reducing the specific surface area of the material can be reached, and the reversible specific capacity, first-cycle efficiency, cycle and rate performance of the obtained carbon-based anode material can also be ensured.

The specific embodiments described above further explain the objectives, technical solutions and beneficial effects of the present disclosure. It should be understood that the above description is only the specific embodiments of the present disclosure, and not intended to limit the scope of the present disclosure. Any modifications, equivalents, improvements and the like made without departing from the spirit and principle of the present disclosure should be included in the scope of the present disclosure.

1. A preparation method of a carbon-based anode material with high slope capacity, comprising:
placing a carbon source precursor in a crucible, placing the crucible in a heating device, and heating to 400° C.-1000° C. at a heating rate of 0.2° C./min-30° C./min under an inert atmosphere, wherein the carbon source precursor includes: any one or a combination of at least two of fossil fuels, biomass, resins, and organic chemicals;
wherein the fossil fuels comprise: one or more of anthracite, bituminous coal, pitch, coal tar, and paraffin; the biomass comprises one or more of corn stalks, lignin, cellulose, glucose, and starch; the resins comprise one or more of phenolic resin, epoxy resin, polyamide resin, polyester resin, and rosin; the organic chemicals comprise: one or more of sodium carboxymethyl cellulose and sodium citrate; and
carrying out low-temperature heat treatment on the carbon source precursor at 400° C.-1000° C. for 0.5-48 hours of time, to carbonize the carbon source precursor, thus obtaining the carbon-based anode material with high slope capacity, wherein, the carbon-based anode material obtained by the low-temperature heat treatment has a specific surface area of less than 10 m²/g, a slope capacity of 180 mAh/g or above, and an initial Coulombic efficiency of 75% or above.

2. The preparation method according to claim 1, wherein temperature for the low-temperature heat treatment is 600° C.-900° C., the time is from 0.5 hours to 10 hours, and the heating rate is 1° C./min-10° C./min.

3. The preparation method according to claim 1, wherein inert gas forming the inert atmosphere comprises any one of N₂, Ar, Ar-5%H₂, Ar-10%H₂, and Ar-40%H₂.

4. The preparation method according to claim 3, wherein the carrying out low-temperature heat treatment on the carbon source precursor further comprises: introducing the inert gas and a hydrocarbon-containing gas during the low-temperature heat treatment process, so that the carbon source precursor is subjected to surface coating during carbonization, wherein the hydrocarbon-containing gas comprises one or more of methane, ethane, toluene, ethylene, acetylene, and propyne, with a flow rate of 0.5-200 mL/min.

5. The preparation method according to claim 1, wherein before the carbonization of the carbon source precursor, the method further comprises:
pretreating the carbon source precursor,
wherein the pretreatment comprises one or more of pre-oxidation, acid washing, alkali washing, water washing, organic solvent washing, and carbon coating treatment.

6. The preparation method according to claim 1, wherein after the carbonization of the carbon source precursor, the method further comprises:
carrying out acid washing, alkali washing, water washing, organic solvent washing and/or carbon coating treatment on carbonization product.

7. A carbon-based anode material prepared by the preparation method according to claim 1, wherein the specific surface area of the carbon-based anode material is less than 10 m²/g, and an intensity ratio ID/IG of the D-peak and G-peak in a Raman spectrum is between 1.5 and 5.

8. The carbon-based anode material according to claim 7, wherein the carbon-based anode material is used as an anode material of a secondary battery.

9. A secondary battery, comprising the carbon-based anode material according to claim 8.
